(19) United States
(12) Patent Application Publication
(10) Pub. No.: US 2015/0181650 A1
(43) Pub. Date: Jun. 25, 2015

(54) GRAPHENE MICROHEATER AND METHOD OF MANUFACTURING THE SAME

(71) Applicant: RESEARCH & BUSINESS FOUNDATION SUNGKYUNKWAN UNIVERSITY, Suwon-si (KR)

(72) Inventors: Sang-Woo KIM, Yongin-si (KR); Christian FALCONI, Rome (IT); Usman KHAN, Abbottabad (PK); Tae-Ho KIM, Seoul (KR); Kang Hyuck LEE, Incheon (KR)

(73) Assignee: RESEARCH & BUSINESS FOUNDATION SUNGKYUNKWAN UNIVERSITY, Suwon-si (KR)

(21) Appl. No.: 14/575,806

(22) Filed: Dec. 18, 2014

(30) Foreign Application Priority Data
Dec. 20, 2013 (KR) 10-2013-0160373
Nov. 5, 2014 (KR) 10-2014-0153036

(51) Int. Cl. H05B 3/00; H01C 17/06

(52) U.S. Cl. CPC H05B 3/0014; H01C 17/06

(57) ABSTRACT

A microheater and a method of manufacturing the same are disclosed. The microheater includes a substrate, graphene disposed on the substrate and formed in a pattern; and a passivation layer disposed on the graphene. The method of manufacturing a microheater involves transferring graphene to a substrate, forming a first pattern for supplying electric power to the graphene, forming an electrode on the first pattern, forming a second pattern for focusing heating in the graphene, and forming a passivation layer on the graphene having the electrode and the second pattern formed therein.

### CROSS-REFERENCE TO RELATED APPLICATION

This application claims the benefit under 35 USC 119(a) of Korean Patent Application No. 10-2013-0160373, filed on Dec. 20, 2013 and Korean Patent Application No. 10-2014-0153036, filed on Nov. 5, 2014, the entire disclosure of which is incorporated herein by reference for all purposes.

### BACKGROUND

1. Field

The following description relates to a microheater and a method of manufacturing the same, and to a microheater using stacked layer structure of graphene and hexagonal boron nitride and a method of manufacturing the same.

2. Description of Related Art

Microheaters are small high power heaters in which high-temperature heat is locally generated on a substrate by using electric power. In recent years, the potential of using microheaters for the purpose of improving sensitivity of gas sensors and controlling a chemical reaction in micro-areas has been researched.

Microheaters may be applied to various electronic devices, such as carbon nanotube transistors, or low temperature polycrystalline silicon or thin-film transistors, which require a high-temperature manufacturing process, or a high-temperature operating process.

The microheaters may include a heating element that is configured to generate heat and emit light. The heating element is formed by a method that involves sputtering or E-beam evaporation (see Korean Unexamined Patent Application Publication No. 10-2009-0032926).

The use of conventional microheaters is limited by its complicated fabrication processes because the microheaters are manufactured by performing a chemical or physical vapor deposition process and an etching process several times.

Further, conventional microheaters require high manufacturing costs as the manufacturing requires expensive materials such as platinum (Pt), gold (Au) or tungsten (W) for filaments used in a heat source of a heater. Further, the manufacturing process conditions are stringent since a vacuum atmosphere and a high temperature are required to deposit and etch such a material.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a microheater that uses graphene.

In another general aspect, a microheater includes a substrate, graphene disposed on the substrate and formed in a pattern, and a passivation layer disposed on the graphene.

The substrate may be a flexible substrate.

The pattern may include a first pattern configured to supply electric power to the graphene, and a second pattern configured to focus heat in the graphene.

The first pattern may be formed to extend to both sides of the microheater.

The general aspect of the microheater may further include an electrode deposited on the first pattern, and the electrode may include titanium and gold, and the titanium may be deposited on the first pattern, and the gold may be deposited on the titanium.

The titanium may have a thickness of 10 nm or less.

The second pattern may include a core region and a plurality of lines, the plurality of lines surrounding the core region in a state in which the plurality of lines are spaced apart from the core region, and the plurality of lines being connected to each other.

The passivation layer may have a flat surface, have a surface roughness (RMS: root mean square) of less than 0.4 nm and a thickness corresponding to one atom, and may comprises a material containing no dangling bonds. The passivation layer may be an insulator having a dielectric constant of greater than 2 and a breakdown electric field of greater than 1.5 MV/cm. The passivation layer may have higher thermal conductivity than the air, and may include a material that does not react with oxygen up to a temperature of 850° C.

The passivation layer may be made of hexagonal boron nitride.

In another general aspect, a method manufacturing a microheater involves transferring graphene to a substrate, forming a first pattern for supplying electric power to the graphene, forming an electrode on the first pattern, forming a second pattern for focusing heating in the graphene, and forming a passivation layer on the graphene having the electrode and the second pattern formed therein.

The forming of the electrode on the first pattern may include depositing titanium on the first pattern, and depositing gold on the titanium.

The transferring of the graphene may include transferring a graphene sheet grown on a base to the substrate by releasing the graphene sheet from the base.

In another general aspect, a microheater may include a substrate, a patterned graphene disposed on the substrate, the patterned graphene having a first pattern that extends from a second pattern having a core region, and a electrode on the first pattern.

The second pattern further may include one or more ring surrounding the core region.

The general aspect of the microheater may further include a passivation layer including hexagonal boron nitride disposed on the patterned graphene.

The microheater may be configured to generate a temperature of 200° C. or greater when a voltage of 64 V is applied to the electrode.

Other features and aspects will be apparent from the following detailed description, the drawings, and the claims.

### BRIEF DESCRIPTION OF THE DRAWINGS

FIG. 1 is a diagram illustrating an example of a microheater according to the present disclosure.

FIG. 2 is a diagram illustrating graphene having patterns formed therein according to one example of the present disclosure.

FIG. 3 is a flowchart illustrating an example of a method of manufacturing a microheater according to the present disclosure.

FIG. 4A is an optical microscope image of an example of a microheater having a polyethylene naphthalate (PEN) substrate.

FIG. 4B is an optical microscope image of an example of a microheater having a polyimide (PI) substrate.

FIG. 5A is a thermographic camera image of an example of a microheater having a PEN substrate.

FIG. 5B is a thermographic camera image of an example of a microheater having a PI substrate.

FIG. 6A is a graph illustrating changes in an exothermic temperature according to changes in an applied voltage in an example of a microheater having a PEN substrate.

FIG. 6B is a graph illustrating changes in an exothermic temperature according to changes in an applied voltage in an example of a microheater having a PI substrate.

FIG. 7 is an image obtained by measuring a temperature distribution of heat generated in an example of a microheater according to the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless specifically stated otherwise, all the technical and scientific terms used in this specification have the same meanings as what are generally understood by a person skilled in the related art to which the present disclosure belongs. In general, the nomenclatures used in this specification and the experimental methods described below are widely known and generally used in the related art.

It is apparent to that various changes and modifications can be made to exemplary embodiments of the present disclosure, and the present disclosure can encompass various exemplary embodiments. Therefore, certain exemplary embodiments are illustrated in the accompanying drawings, and described in further detail in the detailed description. However, it should be understood that scope of the disclosure is not intended to be limited to the particular forms disclosed and the disclosure covers all modifications, equivalents, and alternatives falling within the spirit and scope of the disclosure as defined by the appended claims.

Hereinafter, preferred embodiments of the present disclosure will be described in detail below with reference to the accompanying drawings. In the drawings, like elements have like reference numerals.

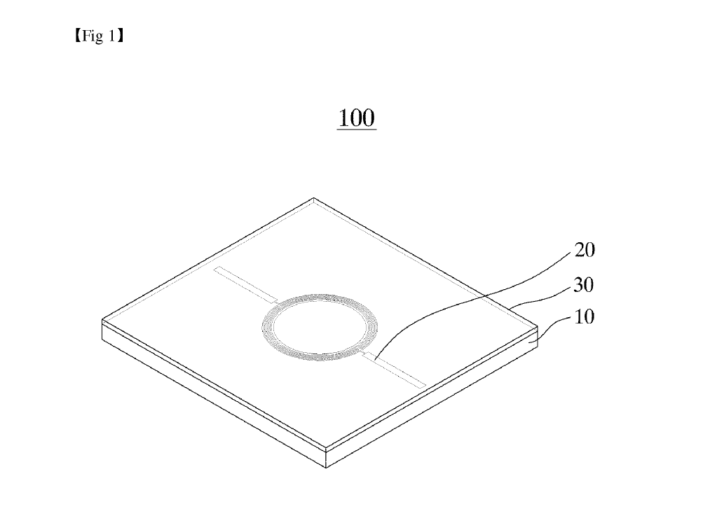

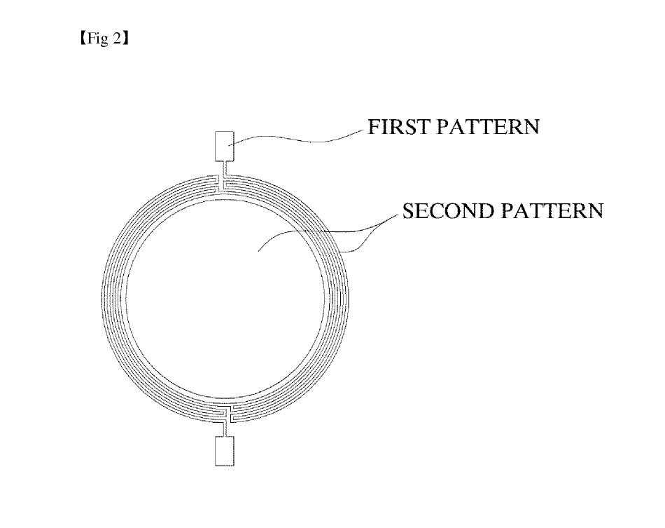

FIG. 1 is a diagram that explains the structure of a microheater according to one example of the present disclosure, and FIG. 2 is a diagram that explains graphene having patterns formed therein according to one example of the present disclosure.

Referring to FIGS. 1 and 2, the microheater 100 according to one embodiment of the present disclosure may include a substrate 10, graphene 20, and a passivation layer 30.

The substrate 10 may be a flexible substrate. The substrate 10 may be made of a polymeric or synthetic material. For example, a polyethylene naphthalate (PEN) or polyimide (PI) substrate may be used as the substrate 10, but the present disclosure is not limited thereto.

The graphene 20 may be disposed on the substrate 10, and may be a patterned graphene formed into a pattern or a shape. The pattern formed by the graphene 20 may include a first pattern for supplying electric power to the graphene 20, and a second pattern capable of focusing heat in the graphene 20.

Referring to FIG. 2, the second pattern may include a circular core region, and a plurality of lines surrounding the core region. For example, the plurality of lines may be arranged to surround the circular core region in a state in which the plurality of lines are spaced apart from the circular core region.

The plurality of lines may be connected to each other, and the first pattern may be disposed at ends of the line surrounding the outermost region of the core region.

For example, the first pattern may be disposed in an opposite direction with respect to the core region of the second pattern, but the present disclosure is not limited thereto.

For example, the first pattern may extend to both sides of the microheater 100. This is merely to be able to externally couple the electrode formed in the first pattern to a power supply to easily supply electric power to the graphene 20.

The circular core region corresponds to a region that is heated while focusing heat. That is, heat may be focused in the core region surrounded by the plurality of lines. The plurality of lines may make an area of long and narrow surface in which heat may be generated in order to increase resistance of the graphene 20, resulting in a further increase in exothermic temperature of the graphene 20. A method of forming a pattern will be described below.

Moisture and oxygen atoms are bound to a surface of graphene exposed to the air over time, and thus may serve as factors that degrade the performance of graphene. To prevent the degradation of the performance of graphene, the passivation layer 30 may be disposed on the graphene 20 having the pattern formed therein, and may serve to prevent the performance of the graphene 20 from being degraded.

For this purpose, the passivation layer 30 may have a flat surface, and may have a surface roughness (RMS) of less than approximately 0.4 nm and a thickness corresponding to one atom. Also, the passivation layer 30 may be made of a material containing no dangling bonds. In this case, the passivation layer 30 may be an insulator having a dielectric constant of greater than approximately 2 and a breakdown electric field of greater than approximately 1.5 MV/cm. Also, the passivation layer 30 may have higher thermal conductivity than the air. For example, the passivation layer 30 may be made of a material that does not react with oxygen in an environment with a temperature up to approximately 850° C.

For example, hexagonal boron nitride (h-BN) may be used as the passivation layer 30. The hexagonal boron nitride is a material having the same 2D structure as graphene, and has a single-layer structure in which boron and nitrogen atoms are distributed all over a plane while forming a hexagonal honeycombed structure. The structure of the hexagonal boron nitride is similar to that of graphene; thus, the hexagonal boron nitride is suitable for being used as the passivation layer 30.

The graphene 20 has a metallic property, but the hexagonal boron nitride (h-BN) has an insulator property. Therefore, the hexagonal boron nitride (h-BN) may prevent an electric current from being leaked from the graphene 20, thereby preventing heat-generating performance of the graphene 20 from being degraded.

Also, when the hexagonal boron nitride is used as the passivation layer 30, a higher level of voltage may be applied to the graphene 20. The thermal conductivity of the air is approximately 0.025 W/mK, and the thermal conductivity of the boron nitride is 30 W/mK. When the graphene 20 is protected by the hexagonal boron nitride, heat generated in the graphene 20 is isotropic in all directions of the hexagonal boron nitride, and may be transferred rapidly and uniformly. Therefore, the heat generated in the graphene 20 may be emitted more rapidly, compared to when the graphene 20 is exposed to the air, which leads to improved durability to deterioration of the graphene 20.

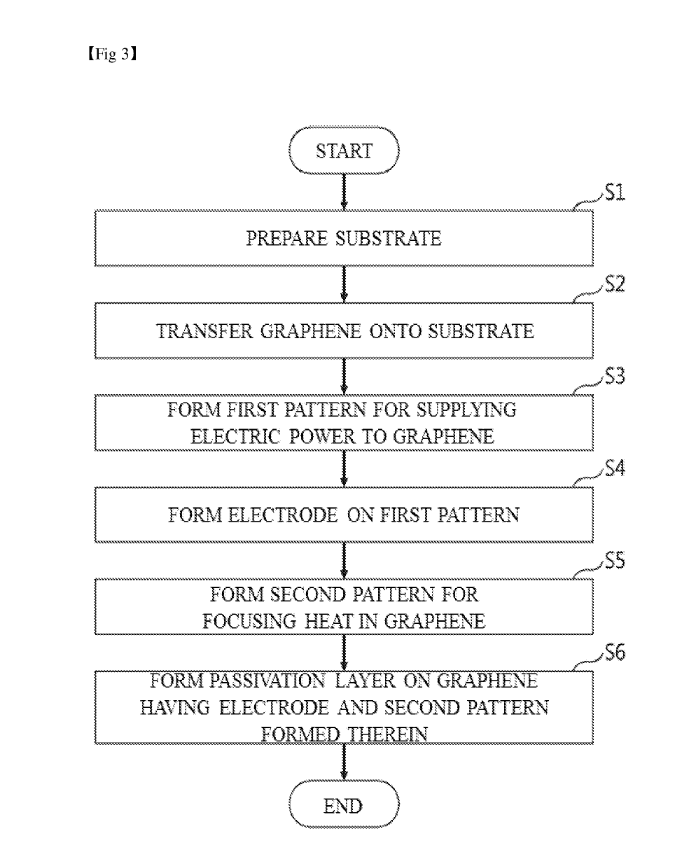

FIG. 3 is a flowchart illustrating a method of manufacturing a microheater according to one exemplary embodiment of the present disclosure.

Referring to FIG. 3, an example of a method of manufacturing a microheater according to the present disclosure may involve the steps of preparing a substrate (S1), transferring graphene onto the substrate (S2), forming a first pattern for supplying electric power to the graphene (S3), forming an electrode on the first pattern (S4), forming a second pattern for focusing heat in the graphene (S5), and forming a passivation layer on the graphene having the electrode and the second pattern formed therein (S6).

Referring to FIG. 3, the substrate 10 is prepared (S1), and graphene is transferred onto the prepared substrate 10 (S2). For example, the graphene 20 may be grown using a copper foil as a base, and the graphene 20 may be transferred onto the substrate 10 and prepared by removing the copper foil.

Graphene is a crystalline allotrope of carbon in which carbon atoms are arranged in a 2-dimensional regular hexagonal pattern in sp2 bonds. Herein, the term graphene refers to a layer of graphene material formed on a base such as a copper foil. The layer may include several sheets of graphene molecules.

To remove the copper foil, an iron chloride (FeCl₃) solution may be used. That is, the copper foil may be etched with an iron chloride (FeCl₃) solution for at least 10 minutes to transfer the graphene 20 grown using the copper foil as a catalyst onto the substrate 10. When the etching time is insufficient, fine copper grains that are not removed remain on a surface of the graphene 20, and thus may serve as a factor that degrades the performance of graphene. The prepared graphene 20 may be transferred onto the substrate 10 using a wet transfer method.

After the graphene 20 is transferred onto the substrate 10, a first pattern for supplying electric power to the graphene 20 is formed (S3). Here, the first pattern may be an electrode pattern.

The first pattern may be formed using a photo-lithography process so that only a portion of the electrode configured to supply electric power to the microheater 100 is selectively developed with a developer. The photo-lithography process may be performed by applying a photoresist, which is a photosensitizer reacting to UV rays, onto the overall graphene 20 using a spin-coating method and developing only a region, in which the electrode is to be formed, with a developer using a selective positive or negative development method. For example, AZ 5214 which may be applied to both of the positive and negative development methods may be used as the photoresist.

Next, an electrode is formed on the first pattern (S4). For example, the electrode is deposited on the first pattern using an e-beam evaporator. The electrode may be formed by depositing titanium (Ti) on the first pattern, followed by depositing gold (Au) on the titanium.

Since gold is weakly adhesive to the graphene 20, titanium (Ti) showing superior adhesion to gold may be used as an intermediate layer configured to attach gold to the graphene 20. In addition to titanium (Ti), another material having a good adhesive property to gold, such as chromium (Cr), may be used as the intermediate layer configured to attach gold to the graphene 20.

For example, titanium (Ti) may be deposited to a thickness of 10 nm or less. This is to reduce contact resistance between the graphene 20 and gold. Also, gold (Au) may be deposited to a thickness of 150 nm or more.

After the electrode is formed, titanium and gold deposited on a region other than the electrode are removed using acetone.

Subsequently, a second pattern for focusing heat in the graphene 20 having the electrode formed therein is formed (S4). The second pattern may be formed between both of the electrodes using a positive photo-lithography process, or an oxygen (O₂) plasma etching process. The second pattern should be disposed between the electrodes, and formed so that the electrodes can be electrically connected to the graphene.

The second pattern may be formed on the graphene 20 using a photo-lithography process, and a positive development method may be used to dispose a photoresist only on a region in which the second pattern is to be formed.

The photoresist remaining after the second pattern is formed on the graphene 20 using the photo-lithography process may be removed using acetone.

The second pattern may be formed by selectively etching a region of the graphene 20 in which the second pattern is to be formed using an oxygen (O₂) plasma etching process. For example, the amount of oxygen (O₂) may be greater than or equal to 5 sccm, the RF power may be greater than or equal to 20 W, the etching time may be less than or equal to approximately 10 seconds, and the working pressure may be approximately 475 mtorr.

After formation of the second pattern, the passivation layer 30 is formed on the graphene 20 having the electrode and second pattern formed therein (S5). For example, the passivation layer 30 may be formed by transferring hexagonal boron nitride (h-BN), which is a 2D planar material, onto the graphene 20. The passivation layer 30 may be transferred onto the graphene 20 using a wet transfer method.

The hexagonal boron nitride (h-BN) may also grow in the same manner as in the graphene 20 using copper foil. Before hexagonal boron nitride (h-BN) is transferred onto the graphene 20, the copper foil may be removed with an iron chloride (FeCl₃) solution to prepare hexagonal boron nitride (h-BN).

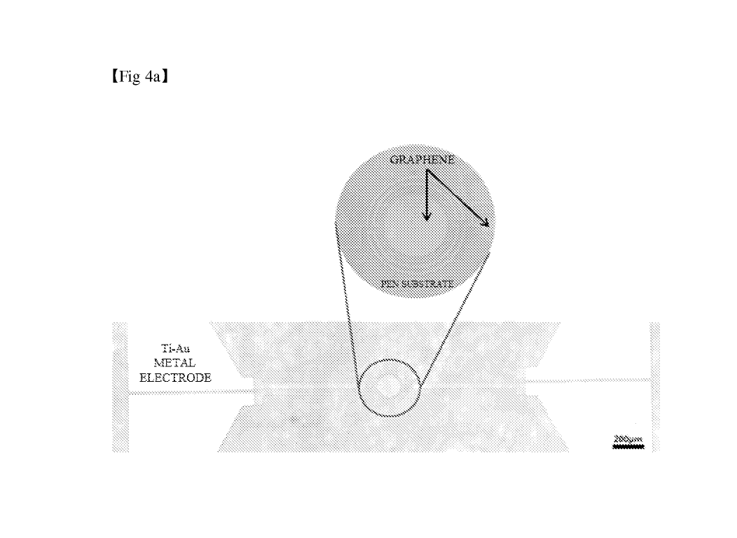

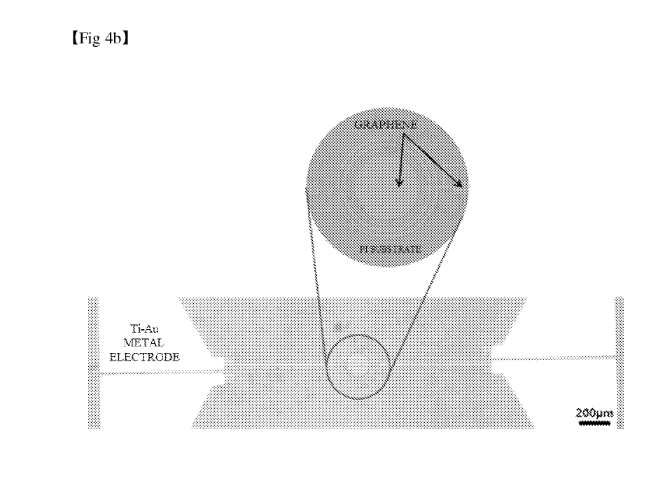

FIG. 4A is an optical microscope image of an example of a microheater having a PEN substrate, and FIG. 4B is an optical microscope image of an example of a microheater having a PI substrate.

Referring to FIGS. 4A and 4B, since the PEN substrate is transparent, but the PI substrate is tinged with red, it can be seen that the color of the microheater 100 in which the substrate is the PI substrate is deeper.

In the case of a single-ring heater composed of the plurality of circularly surrounding lines of the second pattern, the PEN substrate has a minimum line width of approximately 3 μm, and the PI substrate has a minimum line width of approximately 6 μm.

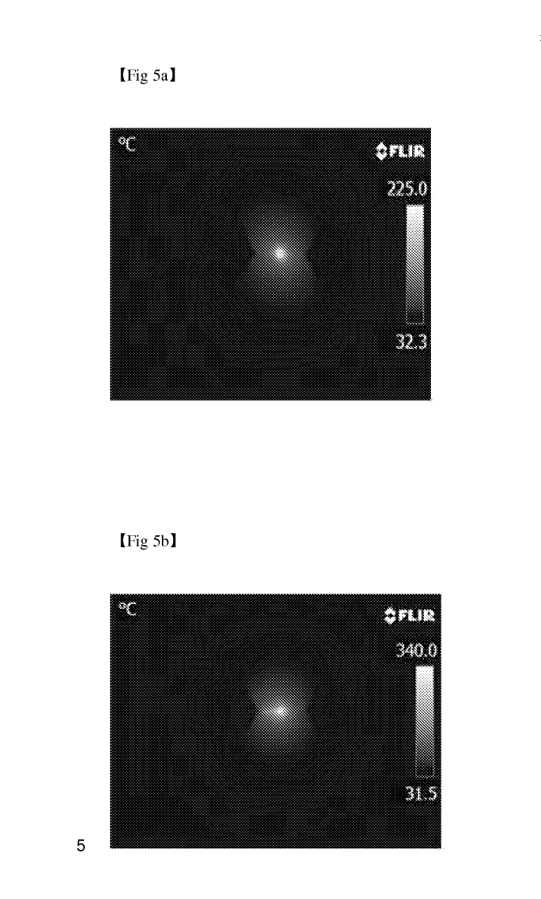

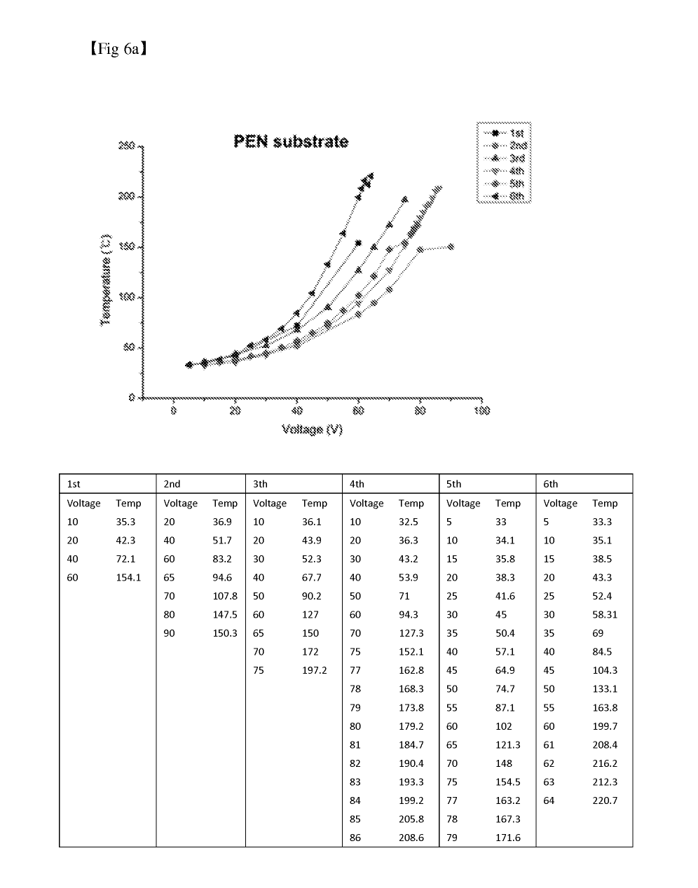

FIG. 5A is a thermographic camera image of the example of the microheater having a PEN substrate, and FIG. 5B is a thermographic camera image of the example of the microheater having a PI substrate.

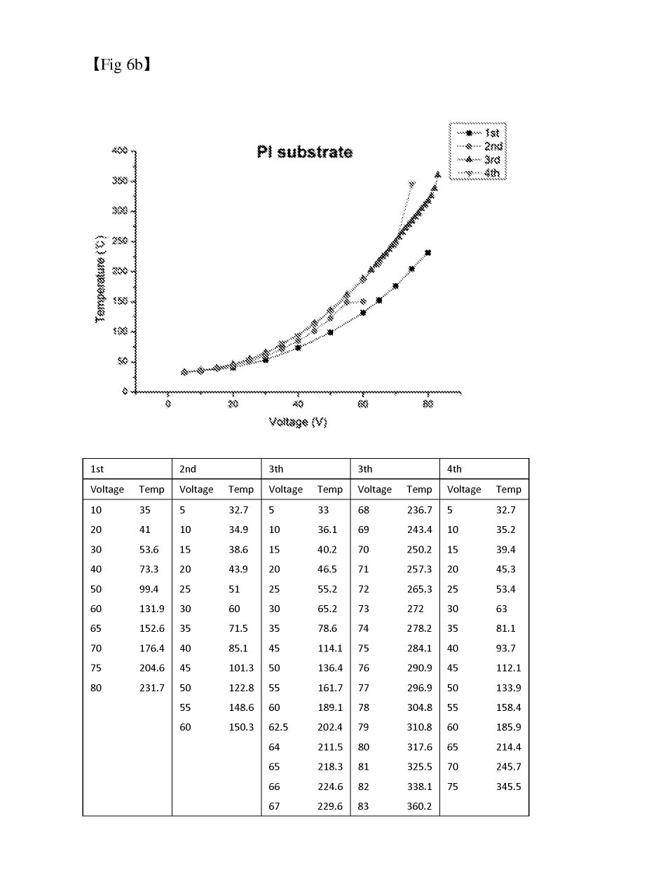

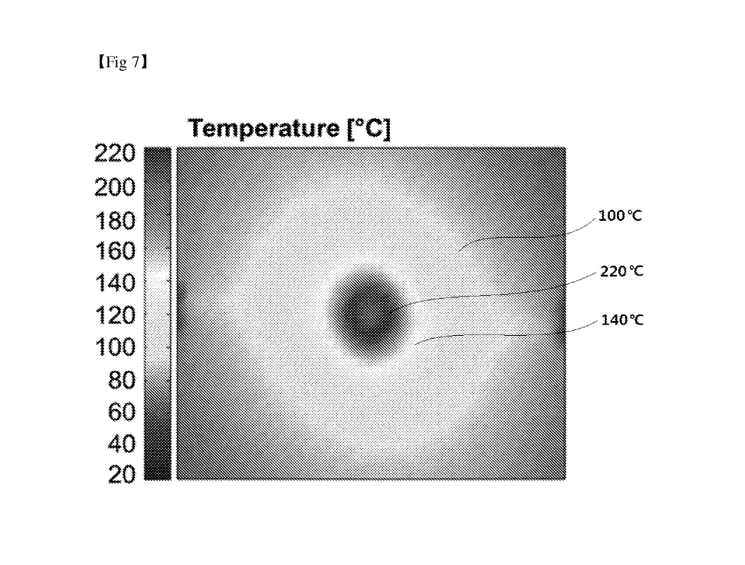

Referring to FIGS. 5A and 5B, it can be seen that the microheater 100 in which the substrate is the PEN substrate is heated to a temperature of approximately 225° C. Also, it can be seen that the microheater 100 in which the substrate is the PI substrate is heated to a temperature of approximately 340° C. The exact temperature of the microheater 100 will be described with reference to FIGS. 6A and 6B below.

FIG. 6A is a graph showing changes in the exothermic temperature of the microheater based on variations in an applied voltage in the example of the microheater having a PEN substrate, and FIG. 6B is a graph showing changes in the exothermic temperature of the microheater based on variations in an applied voltage in the example of the microheater having a PI substrate. The voltage applied to the microheater continues to increase from 5V.

Referring to FIGS. 6A and 6B, it could be seen that the temperature was measured to be approximately 33.3° C. at a point of time at which a voltage of 5 V was applied, which increased with an increasing voltage. The temperature was measured to be approximately 220.7° C. at a voltage of 64 V in the case of the example of a microheater 100 in which a PEN substrate was used.

Also, it could be seen that the temperature was measured to be approximately 33° C. at a point of time at which a voltage of 5 V was applied, which increased with an increasing voltage. The temperature was measured to be approximately 360.2° C. at a voltage of 82 V in the case of the example of a microheater 100 in which the substrate was a PI substrate.

Based on the results, it could be seen that the microheater 100 according to one embodiment of the present disclosure generates heat at a higher temperature than the conventional microheaters.

FIG. 7 is an image obtained by measuring a temperature distribution of heat generated in the microheater according to one embodiment of the present disclosure. FIG. 7 is an image obtained by measuring a temperature distribution of heat generated in the example of the microheater shown in FIG. 1.

Referring to FIG. 7, it could be seen that the microheater 100 according to one embodiment of the present disclosure was able to generate heat having a uniform circular temperature distribution, which corresponded to an arrangement of a circular core region and a plurality of lines surrounding the core region.

The microheater 100 according to one exemplary embodiment of the present disclosure may generate heat having a uniform circular temperature distribution, and thus may easily control uniform heat transfer to an object to be heated. This is because different temperatures of the heat may be transferred to regions of an object to be heated when the heat does not have a uniform temperature distribution, and thus it is very cumbersome and difficult to check and control such a difference in temperatures one by one.

As described above, the microheater according to one exemplary embodiment of the present disclosure can be useful in having a fine size using pliable and transparent graphene, being flexible, and generating heat at a temperature of 300° C. or higher.

Also, the microheater according to one exemplary embodiment of the present disclosure can be useful in reducing the manufacturing cost by replacing a conventional expensive metal heating element such as platinum (Pt), gold (Au), or tungsten (W) with graphene. Further, the microheater according to one exemplary embodiment of the present disclosure can be useful in be manufactured in a simpler manner since the manufacturing process may be performed under low-temperature and normal-pressure conditions, compared to when the conventional metal heating element is used.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A microheater comprising:
a substrate;
graphene disposed on the substrate and formed in a pattern; and
a passivation layer disposed on the graphene.

2. The microheater of claim 1, wherein the substrate is a flexible substrate.

3. The microheater of claim 1, wherein the pattern comprises:
a first pattern configured to supply electric power to the graphene; and
a second pattern configured to focus heat in the graphene.

4. The microheater of claim 3, wherein the first pattern is formed to extend to both sides of the microheater.

5. The microheater of claim 3, further comprising an electrode deposited on the first pattern,
wherein the electrode comprises titanium and gold, and
the titanium is deposited on the first pattern, and the gold is deposited on the titanium.

6. The microheater of claim 5, wherein the titanium has a thickness of 10 nm or less.

7. The microheater of claim 3, wherein the second pattern comprises a core region and a plurality of lines,
the plurality of lines surround the core region in a state in which the plurality of lines are spaced apart from the core region, and
the plurality of lines are connected to each other.

8. The microheater of claim 1, wherein the passivation layer has a flat surface, has a surface roughness (RMS: root mean square) of less than 0.4 nm and a thickness corresponding to one atom, and comprises a material containing no dangling bonds,
the passivation layer is an insulator having a dielectric constant of greater than 2 and a breakdown electric field of greater than 1.5 MV/cm, and
the passivation layer has higher thermal conductivity than the air, and comprises a material that does not react with oxygen up to a temperature of 850° C.

9. The microheater of claim 1, wherein the passivation layer is made of hexagonal boron nitride.

10. A method of manufacturing a microheater, comprising:
transferring graphene to a substrate;
forming a first pattern for supplying electric power to the graphene;
forming an electrode on the first pattern;
forming a second pattern for focusing heating in the graphene; and
forming a passivation layer on the graphene having the electrode and the second pattern formed therein.

11. The method of claim 10, wherein the forming of the electrode on the first pattern comprises:
depositing titanium on the first pattern; and
depositing gold on the titanium.

12. The method of claim 10, wherein the transferring of the graphene comprises transferring a graphene sheet grown on a base to the substrate by releasing the graphene sheet from the base.

13. A microheater comprising:
a substrate;
a patterned graphene disposed on the substrate, the patterned graphene having a first pattern that extends from a second pattern having a core region; and
a electrode on the first pattern.

14. The microheater of claim 13, wherein the second pattern further comprises one or more ring surrounding the core region.

15. The microheater of claim 13, further comprising a passivation layer comprising hexagonal boron nitride disposed on the patterned graphene.

16. The microheater of claim 13, wherein the microheater is configured to generate a temperature of 200° C. or greater when a voltage of 64 V is applied to the electrode.
